(19) United States
(12) Patent Application Publication
(10) Pub. No.: US 2010/0103266 A1
(43) Pub. Date: Apr. 29, 2010

(54) METHOD, DEVICE AND COMPUTER PROGRAM FOR THE SELF-CALIBRATION OF A SURVEILLANCE CAMERA

(76) Inventors: Marcel Merkel, Zuerich (CH); Thomas Jaeger, Stuttgart (DE)

Correspondence Address: MICHAEL J. STRIKER, 103 EAST NECK ROAD, HUNTINGTON, NY, 11743, US

(21) Appl. No.: 12/522,571

(22) PCT Filed: Nov. 2, 2007
(86) PCT No.: PCT/EP07/61808

§ 371 Date: Dec. 2, 2009

(30) Foreign Application Priority Data
Jan. 11, 2007 (DE) 10 2007 001 649.4

(51) Int. Cl. H04N 7/18; H04N 17/00

(52) U.S. Cl. 348/155; 348/187; 348/E07.085; 348/E17.001

(57) ABSTRACT

Video surveillance systems are used, by way of example, for monitoring public places, such as railway stations, junctions, airports, or public buildings, such as libraries, museums, but also private environments, such as an alarm system in houses. To this end, the video surveillance systems often have a plurality of surveillance cameras which observe relevant surveillance scenes. The video sequences produced during observation are usually combined and evaluated at a central location. The invention proposes a method for calibrating a surveillance camera (3), where the surveillance camera (3) depicts a real surveillance scene, which can be described using world coordinates (4), on a surveillance picture (7), which can be described using picture coordinates (4), where at least one trajectory (9) for a moving object (2) in the surveillance scene is determined which comprises a set of position data (10) which describes the position of the moving object (2) using picture coordinates (4) as a function of time, and where the trajectory (9) is used for calibrating the surveillance camera (3) by using a movement model for the moving object (2) to convert the time-dependent position data (10) for the moving object into distances in the real surveillance scene.

### BACKGROUND INFORMATION

The present invention relates to a method for the self-calibration of a surveillance camera, in which the surveillance camera depicts a real surveillance scene which may be described using world coordinates, on a surveillance picture which may be described using picture coordinates, wherein at least one trajectory of a moving object in the surveillance scene is determined, the surveillance scene including a set of position data which describes the position of the moving object using picture coordinates as a function of time, and wherein the trajectory is used for the self-calibration of the surveillance camera; the present invention also relates to a device adapted thereto, and to a computer program.

Video surveillance systems are used, for example, for monitoring public places, such as railway stations, intersections, airports, or public buildings, such as libraries, museums, and also private environments, such as an alarm system in houses. For this purpose, video surveillance systems often include a plurality of surveillance cameras which observe relevant surveillance scenes. The video sequences generated during observation are usually combined and evaluated at a central location.

The evaluation of video sequences may be carried out manually by surveillance personnel. However, this is personnel-intensive and therefore expensive, and it must be noted that alarm situations rarely occur, which means there is a risk that the surveillance personnel will become inattentive due to the prolonged waiting periods between alarm situations. As an alternative, the evaluation may take place automatically using image-processing algorithms. According to a typical approach, moving objects are separated from the essentially static background (object separation) and tracked over time (object tracking), and an alarm is triggered when special conditions, e.g. in terms of the movement pattern or the holding position, are met.

Surveillance cameras are usually installed by installation personnel, for reasons of cost, for example; it cannot be expected that the installation personnel will be capable of performing a complex calibration of the surveillance cameras. For this reason, uncalibrated surveillance cameras are often used in conjunction with automatic evaluation.

As an alternative, calibration methods for surveillance cameras are proposed that permit semi-automatic or even fully automatic self-calibration of the surveillance cameras. For example, U.S. Pat. No. 6,970,083 B2, which is the closest prior art, describes a video surveillance system which, in one possible embodiment, enables semi-automatic calibration of the surveillance cameras that are used. To this end, an individual whose height is known walks through the viewing field of the surveillance camera to be calibrated, so that the video surveillance system may calculate scale information based on the perspective change in size of the individual in various image regions, thereby enabling the surveillance camera to be calibrated. In the case of automatic calibration, random objects are detected in the viewing field of the surveillance camera to be calibrated, and they are arranged in histograms in terms of size and their appearance in the image region. The surveillance camera is calibrated by evaluating the histograms.

### DISCLOSURE OF THE INVENTION

The present invention relates to a method for calibrating a surveillance camera having the features of claim 1, to a device for calibrating a surveillance camera or the surveillance camera having the features of claim 10, and to a computer program for carrying out the method having the features of claim 11. Advantageous and/or preferred embodiments of the present invention result from the dependent claims, the description that follows, and the attached figures.

According to the present invention, a method for calibrating a surveillance camera is presented. The surveillance camera is preferably designed as a fixedly installed and/or non-movable camera which includes a lens having a fixed focal length. As an alternative, it is also possible to use a movable and/or zoomable surveillance camera, in which case, however, the calibration is carried out for all or a large number of position and/or zoom settings. The surveillance camera may have any design, that is, it may be designed as a black/white camera or a color camera, having any type of lens, i.e. in particular a wide-angle, fisheye, telephoto, or 360° lens, and it may be designed for any wavelength, e.g. UV, VIS, NIR or FIR.

In terms of functionality, the surveillance camera depicts a real, three-dimensional surveillance scene, e.g. an intersection, a public place, or the like, on a two-dimensional surveillance picture which could also be referred to as a camera picture. In a mathematical depiction, positions and movements in the surveillance picture may be described using picture coordinates, and they may be described in the surveillance scene using world coordinates. The picture coordinate system and the world coordinate system are selected for purposes of description, but other coordinate systems that are equivalent and/or mathematically equivalent may also be used.

According to the most general definition, the calibration of the surveillance camera includes the determination of camera parameters such as the angle of inclination, roll angle, mounting height, and/or focal length, etc. of the surveillance camera, and/or transformation specifications that describe an angle, a section, a movement or the like in the picture coordinate system in terms of the world coordinate system. In the simplest case, the transformation specifications describe the conversion of a distance of two points in picture coordinates into the corresponding distance in world coordinates.

To carry out the calibration, at least one trajectory of a moving object in the surveillance scene is determined. To improve the calibration, it is advantageous when a large number of trajectories of the moving object and/or a large number of trajectories of various moving objects are/is generated. The trajectory includes a set of position data which describes the position of the moving object using picture coordinates as a function of time. A trajectory describes, in particular, the movement of the moving object as a function of time. Preferably, the centroid of the moving object and/or a box enclosing the object—a “bounding box”—are/is used or applied as trajectory data. In particular, a base of the moving object may be calculated instead of the centroid, since the base is in physical contact—or is nearly in physical contact—with the ground plane of the surveillance scene.

According to the present invention, the trajectory is used to calibrate the surveillance camera by using a movement model for the moving object to convert the time-dependent position data for the moving object into distances in the real surveillance scene. Using the movement model, advance or a priori information about the moving object is incorporated in the calibration, thereby improving it.

The present invention is based on the idea of supporting a semi-automatic or fully automatic calibration of the surveillance camera based not—or not exclusively—on the change in size of the moving object in various image regions of the surveillance picture using perspective effects, but rather by evaluating the movement of the moving object based on a movement model. The method according to the present invention therefore opens up a new information source for an automatic camera calibration which may be used instead of or in addition to the known information sources, thereby making it possible to improve the accuracy or quality of the calibration.

According to a preferred embodiment, the moving object is classified and, based on the classification, it is assigned to an object class having a movement model for objects in this object class, or it is discarded.

In an advantageous embodiment, the moving object is classified as a pedestrian, and a pedestrian movement model is used as the movement model, according to which the movement of the pedestrian at a constant rate of, e.g. 4 km/h is modeled. As an alternative or in addition thereto, movement models of other objects or object classes such as vehicles, objects moved via conveyor belts, etc. may be used. In addition to a simple movement model which assumes a perpetually constant speed, it is also possible to use more complex movement models which, e.g. in cases where direction changes, model a change in speed or waiting positions at a traffic light, or the like.

In an optional embodiment, the time-dependent position data of the trajectory are designed to be equidistant in terms of time. This is the case, in particular, when the surveillance scene is recorded using a constant image frequency, so that the surveillance pictures in a video sequence are situated equidistantly in terms of time, and so that an object position of the moving object is determined for each surveillance picture. In the case of these time-equidistant, time-dependent position data of the trajectory, the distance between two positions as defined by their position data in picture coordinates may be easily converted into a distance in world coordinates when a constant rate of motion is assumed; the distance is calculated by multiplying the rate of motion by the reciprocal of the image frequency.

In a further embodiment of the present invention, the position data are not situated and/or designed in a time-equidistant manner, which results in an only slight increase in the complexity involved in calculating the distance that corresponds to the distance between two position data in picture coordinates in terms of world coordinates, in which case the reciprocal of the image frequency is not used, but rather the distance between the two position data in terms of time. Preferably, the method generally assumes that the trajectory between two position data extends in a straight line or approximately in a straight line.

Expressed more generally, the method according to the present invention provides, in an advantageous embodiment, that a transformation or depiction specification between picture coordinates and world coordinates is determined based on the time-dependent position data. This depiction specification preferably makes it possible to transform or convert any distance between two image points in picture coordinates into a real distance in world coordinates.

In a further development of the method, a plurality of trajectories may also be used by a plurality of moving objects, thereby confirming the depiction specifications using statistics. It is possible to combine a plurality of trajectories, e.g. to average them statistically, and, from this, to derive depiction specifications, and/or to derive depiction specifications that are then combined, e.g. they are averaged statistically. The knowledge of several trajectories is preferably combined using the RANSAC algorithm, which is known to a person skilled in the art, e.g., from the scientific article by D. Greenhill, J. Renno, J. Orwell, and G. A. Jones: Learning the semantic landscape: Embedding scene knowledge in object tracking, Real Time Imaging, Special Issue on Video Object Processing 11, pp. 186-203, 2005, the contents of which in terms of the RANSAC algorithm are incorporated in the present disclosure via reference. The trajectories are preferably recorded during a long-term observation of the surveillance scene, the minimal duration of which depends on the density of the moving objects and lasts, in particular, for several days at lest.

In an advantageous development of the method, further advance information or findings are used in the calibration, such as the utilization of the known height of the moving object as described above. Via the mutual supplementation of several information sources, that is, the evaluation of the trajectory using a movement model, and, e.g. the known height of the moving object, it is possible to further improve the calibration of the surveillance camera.

In an advantageous embodiment of the present invention, the ascertained or calculated distances and/or the transformation specification are/is used to calculate or estimate camera parameters. In this case, the camera parameters are estimated, e.g. using modeling, in such a manner that they correspond to the distances that were determined, and to the transformation specification. The camera parameters are based, in particular, on the height of the surveillance camera above the floor, the inclination angle, and the roll angle of the surveillance camera. Optionally, the camera parameters are also based on the focal length or further optical characteristic values of the surveillance camera. In the case of this embodiment as well, it is possible to utilize additional advance knowledge in the estimation: For example, it may prove to be advantageous when, in the modeling process, the focal length of the surveillance camera or other optical characteristic values of the surveillance camera are already known, so that only the position and orientation parameters are left to be estimated.

According to a further advantageous embodiment of the present invention, the calibration of the surveillance camera is used to estimate a ground plane and/or a ground plane coordinate system. This ground plane or the corresponding coordinate system makes it possible, e.g. to calculate or estimate a horizon in the surveillance picture; image regions that are situated above the estimated or calculated horizon are preferably disregarded in the image processing. This embodiment is based on the idea that no moving objects (pedestrians, cars, etc.) will be situated above the horizon, and that it is therefore superfluous to evaluate these regions.

The present invention also relates to a device for calibrating a surveillance camera, in particular according to the method described in claims 1 through 9, and/or as described above, which is preferably designed as part of a video surveillance system. The device according to the present invention is therefore connected and/or connectable to a plurality of surveillance cameras which, in particular, are directed in a fixed and/or immovable manner to various surveillance scenes.

The device comprises an input module for entering one or more surveillance pictures of a real surveillance scene which may be described using world coordinates. The surveillance scenes are, in particular, a component of one or more video sequences that were recorded using the surveillance camera.

An object tracking module is designed to determine a trajectory of a moving object in the surveillance scene. The object tracking is preferably based, in a known manner, on an object segmentation of the moving object relative to a static or quasi-static background, and on tracking the object over several surveillance pictures in a video sequence. The trajectory includes a set of position data which describes the position of the moving object using picture coordinates as a function of time. Basically, any method of depicting the trajectory that is mathematically equivalent thereto is possible.

A calibration module is designed to perform a calibration of the surveillance camera by using a movement model for the moving object to convert the time-dependent position data for the moving object into distances in the real surveillance scene. Reference is made to the method described above for further details about the calibration or the conversion.

A further subject matter of the present invention relates to a computer program which includes program code means for carrying out all steps of the above-described method or as recited in one of the claims 1 through 9 when the program is run on a computer and/or the device as recited in claim 10.

### BRIEF DESCRIPTION OF THE DRAWING

Further features, advantages, and effects of the present invention result from the description that follows of a preferred embodiment of the present invention, and from the attached figures.

FIGS. 1 through 3 show schematic depictions of coordinate systems for illustrating the concepts that are used;

FIG. 4 shows a surveillance picture including a trajectory sketched therein;

FIG. 5 shows the surveillance picture in FIG. 4 including additional sketched-in trajectories;

FIG. 6 shows a function block diagram of a device for calibrating a surveillance camera, as an exemplary embodiment of the present invention.

### EMBODIMENT(S) OF THE INVENTION

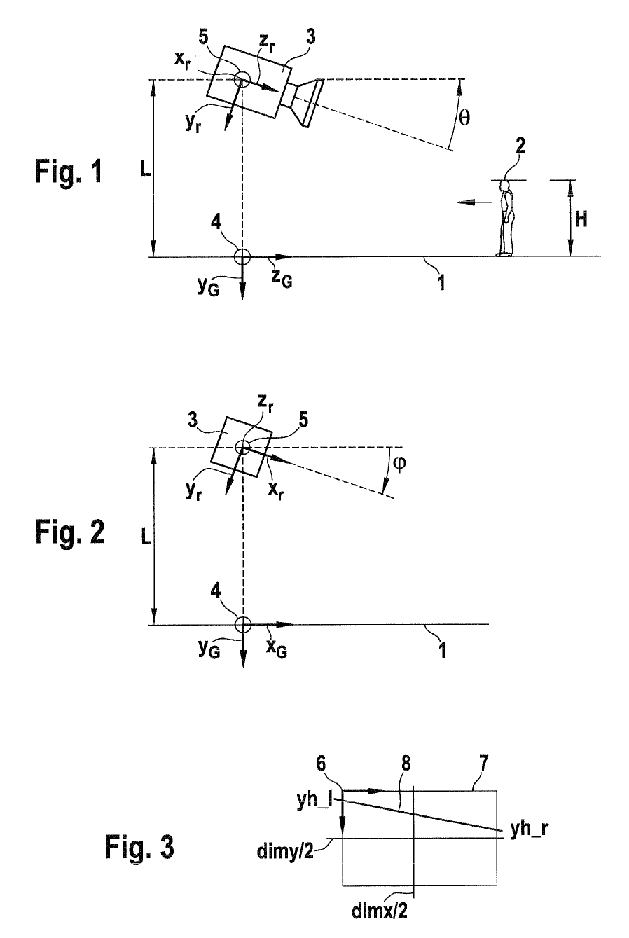

FIG. 1 shows, in a schematic side view, a ground plane 1, on which a moving object—a person 2 in this example—having an object height H moves. Person 2 is recorded together with his environment by surveillance camera 3.

To describe the movement, etc. of person 2 in the environment, a world coordinate system is used, which is depicted in FIG. 1 as a local ground plane coordinate system (GCS) 4. This is a Cartesian coordinate system in which the x-axis and z-axis are coplanar with ground plane 1, and the y-coordinate is oriented at a right angle to ground plane 1.

Surveillance camera 3 will be described using a camera coordinate system (CCS) 5, however. Camera coordinate system 5 has its origin in surveillance camera 3; the z-axis is parallel to the optical axis of surveillance camera 3, and the x- and y-axes are oriented parallel to the side edges of an image-recording sensor element in the surveillance camera.

Camera coordinate system 5 is derived from ground plane coordinate system 4 as follows: First, the origin is shifted by length L which corresponds to the mounting height of surveillance camera 3 above ground plane 1. In a subsequent step, the shifted coordinate system is rotated by a roll angle rho and by an inclination angle theta. It should also be noted that the z-axis of ground plane coordinate system 4 is designed as a vertical projection of the z-axis and, therefore, the optical axis of surveillance camera 3.

FIG. 3 shows an image coordinate system 6 in a surveillance camera 7, which is situated in the top left corner of surveillance picture 7. Horizon 8 is also drawn in surveillance picture 7. Horizon 8 results from mounting height L, roll angle rho, and inclination angle theta, and the further camera parameters of surveillance camera 3.

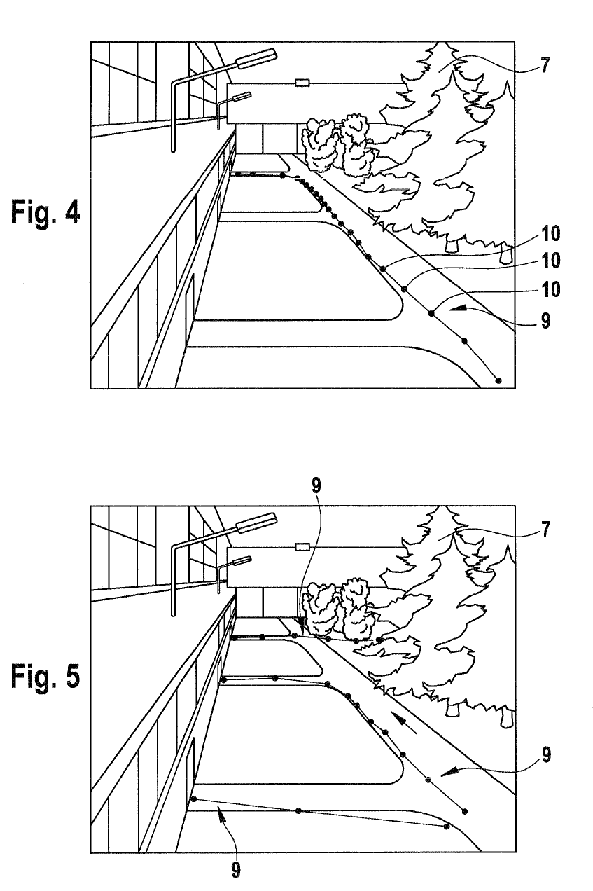

As described above, in the calibration of surveillance camera 3, it is difficult to convert or transfer distances in surveillance picture 7 in picture coordinates 6 in real distances in the surveillance scene into world coordinates or ground plane coordinates 4. For this purpose, the time-dependent trajectories of the moving object (person 2) are evaluated, as explained below with reference to FIGS. 4 and 5.

FIG. 4 shows a surveillance picture 7 in which a trajectory 9 is depicted. Trajectory 9 is composed of individual points 10 which represent the position of the moving object (person 2) in intervals of 2 seconds. If one now assumes that person 2 typically moves at a rate of 4 km/h, the distance between two points 10 is calculated to be approximately 2.2 m. Due to the perspective properties in the transfer of the real scene in world coordinates 4 into a surveillance picture in picture coordinates 6, the distances in picture coordinates 6 between points 10 in the direction of the horizon become smaller or larger in the vicinity of surveillance camera 3. Surveillance picture 7 also shows that the direction of movement also has a substantial effect on the distance between points 10. As person 2 moves away from the surveillance camera, that is, along a vertical or quasi vertical path, the distance between two points 10 becomes increasingly smaller. However, if the person moves horizontally relative to surveillance camera 3, the distance between two points 10 remains approximately the same at the particular same horizontal level. Assuming the movement model of a constant rate of motion of 4 km/h of person 2, trajectory 9 shown in FIG. 4 therefore contains information about the actual distances between two points 10 in world coordinates 4.

FIG. 5 shows identical surveillance picture 7, but including additional trajectories 9; trajectories 9 include horizontally extending path sections. Due to the trajectory sections that extend horizontally but that are separated vertically relative to one another, the distances between points 10 become smaller the further away the horizontal sections are from surveillance camera 3. By utilizing this knowledge, the distance between individual trajectory points 10 and surveillance camera 3 may be estimated in world coordinates 4. However, as soon as the distances are known in world coordinates 4 and, therefore, a depiction specification between picture coordinates 6 and world coordinates 4 is estimated or calculated this knowledge may be used to estimate camera parameters such as the focal length of surveillance camera 3 and, therefore, the angle of observation.

To design the calibration to be as accurate as possible, the surveillance scene is observed for a long period of time, which may amount to several days. Trajectories 9 that are recorded during this time are clustered in order to obtain mean values for the movement times of the common trajectories. It is also possible to use a RANSAC algorithm to combine the knowledge of a large number of trajectories. This step is useful in terms of handling statistical outliers, e.g. persons who are running or who are moving very slowly.

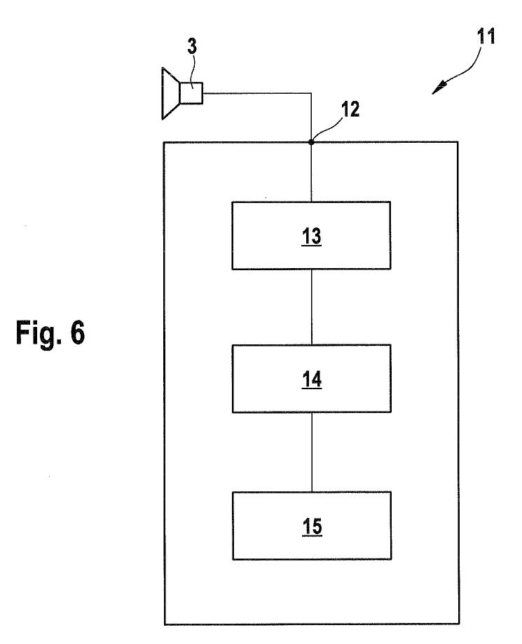

FIG. 6 shows, as a function block diagram, a video surveillance system 11 which is connected via interfaces 12 to a plurality of surveillance cameras 3. The video sequences that are recorded using surveillance cameras 3 are sent to an input module 13 and, from there, they are sent to an object-tracking module 14 which calculates the trajectories of moving objects, e.g. person 2, in the video sequences. In the calibration module 15, the trajectories or the combined trajectories are used to first calculate a depiction specification between picture coordinates 6 and world coordinates 4 and, based thereon, to determine camera parameters and use them to calibrate surveillance camera 3. Surveillance system 11 is preferably designed as a computer, and the method presented is implemented using a computer program.

What is claimed is:

1. A method for calibrating a surveillance camera (3), in which the surveillance camera (3) depicts a real surveillance scene which may be described using world coordinates (4), on a surveillance picture (7) which may be described using picture coordinates (4),
and at least one trajectory (9) of a moving object (2) in the surveillance scene is determined, the surveillance scene comprising a set of position data (10) which describes the position of the moving object (2) using picture coordinates (4) as a function of time, and
the trajectory (9) is used to calibrate the surveillance camera (3) by using a movement model for the moving object (2) to convert the time-dependent position data (10) for the moving object into distances in the real surveillance scene.

2. The method as recited in claim 1,
wherein
the moving object (2) is classified.

3. The method as recited in claim 1,
wherein
the movement model is designed as a pedestrian movement model which assumes a constant rate of motion of the pedestrian.

4. The method as recited in claim 1, wherein
the time-dependent position data (10) are designed to be equidistant in terms of time, and wherein the distance between two image points of two position data in picture coordinates (4) is converted into a distance in world coordinates (6) in the real surveillance scene.

5. The method as recited in claim 1,
wherein
a transformation specification between picture coordinates (4) and world coordinates (6) is determined.

6. The method as recited in claim 1,
wherein
a large number of trajectories (8) that are statistically combined with one another is ascertained and utilized.

7. The method as recited in claim 1,
wherein
further advance knowledge is used for the calibration.

8. The method as recited in claim 1,
wherein
the ascertained distances and/or the transformation specification are/is used to calculate or estimate camera parameters (L, rho, theta).

9. The method as recited in claim 1,
wherein
a ground plane (1) in the surveillance scene is ascertained.

10. A device for calibrating a surveillance camera, which is preferably designed for use with the method as recited in claim 1,
comprising an input module (12) for entering one or more surveillance pictures of a real surveillance scene which may be described using world coordinates (4),
comprising an object-tracking module (13) which is designed to determine a trajectory (9) of a moving object (2) in the surveillance scene, the trajectory (9) comprising a set of position data (10) which describes the position of the moving object (2) using picture coordinates (6) as a function of time, and
comprising a calibration module (14) which is used to calibrate the surveillance camera (3) by using a movement model for the moving object (2) to convert the time-dependent position data for the moving object (2) into distances in the real surveillance scene.

11. A computer program comprising program code means for carrying out all steps of the method as recited in claim 1 when the program is run on a computer and/or the device.
